(19) United States
(12) Patent Application Publication
(10) Pub. No.: US 2010/0059294 A1
(43) Pub. Date: Mar. 11, 2010

(54) BANDWIDTH ENHANCEMENT FOR A TOUCH SENSOR PANEL

(75) Inventors: John Greer Elias, Townsend, DE (US); Steve Porter Hotelling, San Jose, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 12/206,680

(22) Filed: Sep. 8, 2008

(51) Int. Cl. G06F 3/044

(52) U.S. Cl. 178/18.06; 345/174

(57) ABSTRACT

A system is disclosed for enhancing the stimulation signal bandwidth for a touch sensor panel and maintaining relatively uniform touch sensitivity over the touch sensor panel surface. In one embodiment, a bandwidth enhancement circuit is coupled in parallel to a sensor circuit. The sensor circuit includes a source of stimulating voltage, a drive line, a sense line, and a charge amplifier. The drive line and the sense line are coupled with each other by a mutual capacitance Csig. The bandwidth enhancement circuit can be a RC circuit coupled in parallel to the sensor circuit. The bandwidth enhancement circuit can be represented by two serially coupled resistors, each of which is also coupled to ground on one end, and two capacitors. In particular, one of the capacitors couples the bandwidth enhancement circuit to the drive line, and the other capacitor couples the bandwidth enhancement circuit to the sense line.

### FIELD OF THE INVENTION

This relates generally to input devices for computing systems, and more particularly, to a bandwidth enhancement for a touch sensor panel.

### BACKGROUND OF THE INVENTION

Many types of input devices are presently available for performing operations in a computing system, such as buttons or keys, mice, trackballs, touch sensor panels, joysticks, touch screens and the like. Touch screens, in particular, are becoming increasingly popular because of their ease and versatility of operation as well as their declining price. Touch screens can include a touch sensor panel, which can be a clear panel with a touch-sensitive surface. The touch sensor panel can be positioned in front of a display screen so that the touch-sensitive surface covers the viewable area of the display screen. Touch screens can allow a user to make selections and move a cursor by simply touching the display screen via a finger or stylus. In general, the touch screen can recognize the touch and position of the touch on the display screen, and the computing system can interpret the touch and thereafter perform an action based on the touch event.

In some configurations, touch sensor panels can be implemented as an array of pixels formed by multiple drive lines (e.g. rows) crossing over multiple sense lines (e.g. columns), where the drive and sense lines are separated by a dielectric material. However, to reduce the cost of manufacturing touch sensor panels and reduce the thickness of the panels, advanced touch sensor panels may include an array of co-planar single-layer touch sensors fabricated on a single side of a substrate. In this advanced configuration, the sense lines can be continuous and maintain their generally columnar shape, but the drive lines may need to be formed from discrete shapes (bricks) coupled in the border areas of the panel using thin connecting traces. For example, each drive line can be formed from a row of discrete bricks coupled together by thin connecting traces. However, the separation of the drive bricks and the spacings required by the connecting traces may cause a problem with respect to the uniformity of the sensitivity of the panel and the bandwidth of stimulation signals that can be applied to the panel.

### SUMMARY OF THE INVENTION

Embodiments of this invention relate to enhancing the stimulation signal bandwidth of a touch sensor panel by forming a conductive strip between the drive bricks and the sense lines. While other types of touch sensor panels may benefit from the bandwidth enhancement disclosed herein, the bandwidth enhancement is most suitable for touch sensor panels having an array of co-planar single-layer touch sensors fabricated on a single side of a substrate (e.g., a 2-dimensional capacitive SITO surface). The panel can be adapted for detecting single or multi-touch events (the touching of one or multiple fingers or other objects upon a touch-sensitive surface at distinct locations at about the same time).

In one embodiment, the present invention provides a solution for enhancing the stimulation signal bandwidth for the touch sensor panel, maintaining relatively uniform touch sensitivity over the touch sensor panel surface, minimizing border space needed outside the display area, and maximizing the sensing element area inside the display area. In general, embodiments of the invention enhance the bandwidth of the sensor signal by adding geometry to the sensing elements that are designed to maintain the signal strength over a wider range of stimulating frequencies, counteracting the negative effects of the narrower drive lines.

In one embodiment, a basic sensor circuit is coupled in parallel with a bandwidth enhancement circuit. The electrical model of the sensor circuit includes a source of stimulating voltage, a drive line (e.g., a row line), a sense line (e.g., a column line), and a charge amplifier. The drive line and the sense line are coupled with each other by a mutual capacitance Csig.

The bandwidth enhancement circuit serves as another pathway to allow the stimulating signal to travel between the drive line and the sense line. The bandwidth enhancement circuit can be another RC circuit coupled in parallel to the sensor circuit. As such, the bandwidth enhancement circuit is also frequency dependent, but produces an increase in the total bandwidth of the overall circuit.

In this embodiment, the bandwidth enhancement circuit can be represented by two serially coupled resistors, each of which is also coupled to ground on one end, and two capacitors. In particular, one of the capacitors couples the bandwidth enhancement circuit to the drive line, and the other capacitor couples the bandwidth enhancement circuit to the sense line.

### BRIEF DESCRIPTION OF THE DRAWINGS

FIG. 1A illustrates an exemplary touch sensor panel including columns, rows of bricks, and connecting traces routed along only one side of the bricks.

FIG. 1B illustrates a close-up view of a portion of the exemplary touch sensor panel of FIG. 1A, showing bricks routed to bus lines using connecting traces in a single escape configuration.

FIG. 1C illustrates a portion of the exemplary touch sensor panel of FIG. 1A, including bricks associated with columns C0 and C1 and connecting traces coupling the bricks to the bus lines.

FIG. 1D illustrates a portion of another exemplary touch sensor panel, including an interlocking pattern of bricks and columns.

FIG. 2A illustrates an exemplary electrical model of a single-layer indium tin oxide (SITO) sensor, drive and sense routing, and a sense amplifier.

FIG. 2B illustrates a modified electrical model of the SITO sensor of FIG. 2A that includes a bandwidth enhancement component according to embodiments of the invention.

FIG. 3 illustrates a portion of the exemplary touch sensor panel of FIG. 1D, including a bandwidth enhancement strip positioned between a drive electrode and a sense electrode according to embodiments of the invention.

FIG. 4 is a graph illustrating the improvement in signal strength of a touch sensor panel fitted with the bandwidth enhancement component according to an embodiment of the invention.

FIG. 5 illustrates an exemplary computing system operable with a touch sensor panel having the bandwidth enhancement component according to embodiments of this invention.

FIG. 6a illustrates an exemplary mobile telephone that can include a touch sensor panel with the bandwidth enhancement component according to embodiments of the invention.

FIG. 6b illustrates an exemplary media player that can include a touch sensor panel with the bandwidth enhancement component according to embodiments of the invention.

FIG. 6c illustrates an exemplary personal computer that can include touch sensor panel with the bandwidth enhancement component according to embodiments of the invention.

### DETAILED DESCRIPTION OF THE PREFERRED EMBODIMENTS

In the following description of preferred embodiments, reference is made to the accompanying drawings which form a part hereof and in which it is shown by way of illustration specific embodiments in which the invention can be practiced. It is to be understood that other embodiments can be used and structural changes can be made without departing from the scope of the embodiments of this invention.

It is preferable in the design of any touch sensor panel to achieve uniform touch sensitivity in the sensing area of the panel so that the sensed signal strength is independent of the position where a touch event is sensed across the surface of the panel. Uniform touch sensitivity can generally be achieved by uniform spacing of the sensors in the touch sensor panel. However, in single-sided touch panels with drive lines formed from rows of interconnected drive bricks, substantially uniform spacing can only be achieved by using thin connecting traces for connecting to the drive bricks. However, the thin connecting traces produce RC circuits which tend to limit the frequency of the stimulation signals that can be applied to the drive lines.

Embodiments of this invention relate to enhancing the stimulation signal bandwidth of a touch sensor panel by forming a conductive strip between the drive bricks and the sense lines. While other types of touch sensor panels may benefit from the bandwidth enhancement disclosed herein, the bandwidth enhancement is most suitable for touch sensor panels having an array of co-planar single-layer touch sensors fabricated on a single side of a substrate (e.g., a 2-dimensional capacitive SITO surface). The panel can be adapted for detecting single or multi-touch events (the touching of one or multiple fingers or other objects upon a touch-sensitive surface at distinct locations at about the same time).

In typical single-sided mutual capacitance touch sensor panels, each sensor or pixel can be the result of interactions between drive and sense lines. The sense (or drive) lines can be fabricated in a single strip as, for example, columnar, fingered or zigzag patterns in a first orientation, and the drive (or sense) lines can be fabricated, for example, as rows of discrete polygonal (e.g., finger-shaped) conductive areas in a second orientation. Exemplary embodiments of the sense lines and drive lines are described in more detail below. Because the drive and sense lines can be formed on the same layer, manufacturing costs can be reduced and the touch sensor panel can be made thinner. Each sense (or drive) line in the first orientation can be coupled to a separate metal trace in the border area of the touch sensor panel, and each polygonal area in the second orientation can also be coupled to a metal trace in the border area of the touch sensor panel. The metal traces in the border areas can be formed on the same side of the substrate as the drive and sense lines. The metal traces can allow both the row and column lines to be routed to the same edge of the substrate so that a small flex circuit can be bonded to a small area on only one side of the substrate.

However, a problem exists in this type of co-planar single layer touch sensor panel as a result of the spacing needed between drive and sense lines and the spacing needed to route connecting traces to the drive lines. More specifically, sensors covering various spots of a single layer touch sensor panel surface may have different sensitivities to the same touch event depending on where the sensors are located on the surface. It may not be difficult to achieve uniform sensitivity in the Y dimension because the sense lines run in this dimension and are uninterrupted from top to bottom of the panel. However, because the drive lines and their connecting traces are also formed in the same co-planar single layer, the drive lines and connecting traces tend to push the sense lines apart in a second dimension (e.g., the horizontal X-dimension). To counteract this effect and maintain uniform touch sensitivity, it may be desirable to have very narrow drive lines to increase the space allotted for the sense lines. In addition, because the drive lines typically have a very high sheet resistance, it is also necessary to keep the drive lines away from each other to minimize cross talk between them. This provides another incentive to use narrow drive lines. However, an undesirable effect exists due to the inherent higher resistance of narrower driver lines. That is, the stimulating signal bandwidth may be reduced due to the increased time constant introduced by these narrower, higher resistance drive lines, causing the touch panel to be less sensitive and more nonuniform. Therefore, a balance between the areas allocated for drive routing and for sensing is desirable to prevent a significant reduction in stimulation signal bandwidth and maintain touch sensitivity over the entire touch sensor panel surface.

In one embodiment, the present invention provides a solution for enhancing the stimulation signal bandwidth for the touch sensor panel, maintaining relatively uniform touch sensitivity over the touch sensor panel surface, minimizing border space needed outside the display area, and maximizing the sensing element area inside the display area. In general, embodiments of the invention enhance the bandwidth of the sensor signal by adding geometry to the sensing elements that are designed to maintain the signal strength over a wider range of stimulating frequencies, counteracting the negative effects of the narrower drive lines.

Although some embodiments of this invention may be described and illustrated herein primarily for use in mutual capacitance multi-touch sensor panels, it should be understood that embodiments of this invention are not so limited, but can be additionally applicable to self-capacitance sensor panels and single-touch sensor panels. Furthermore, although the touch sensors in the sensor panel may be described and illustrated herein in terms of generally orthogonal arrangements of drive (or sense) lines formed as rows of rectangular bricks or other polygonal shapes, and sense (or drive) lines formed as columnar or zigzag patterns, embodiments of this invention are not limited to be used only with the described sensors, but can be additionally applicable to sensors with drive lines and sense lines in other patterns.

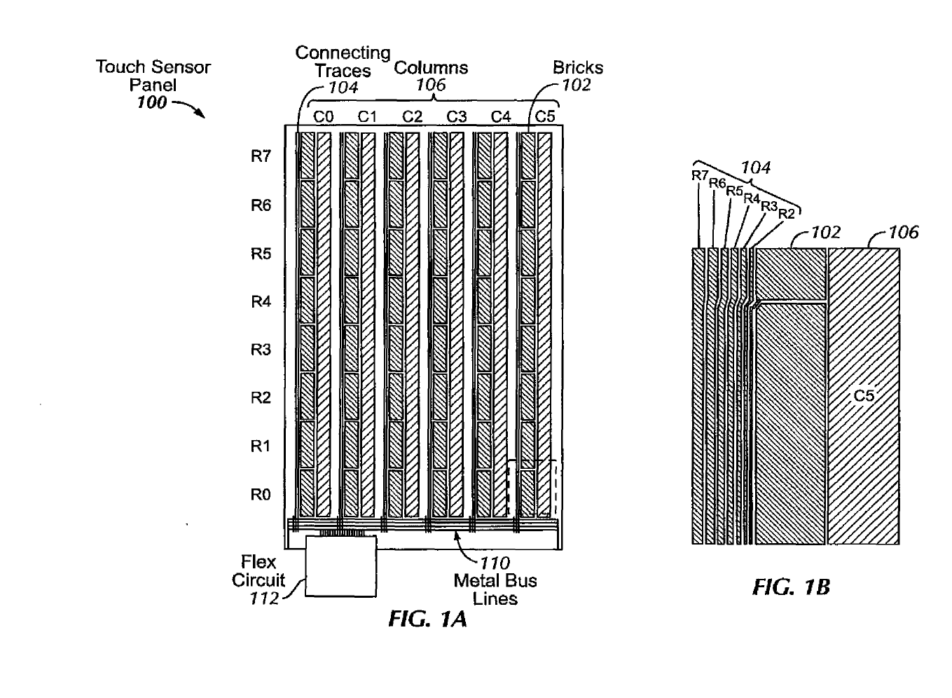

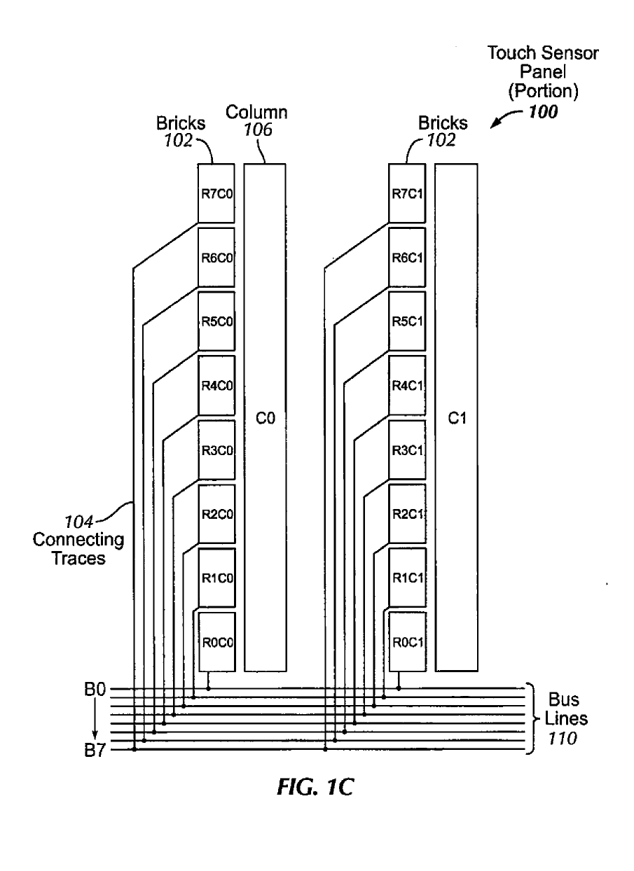

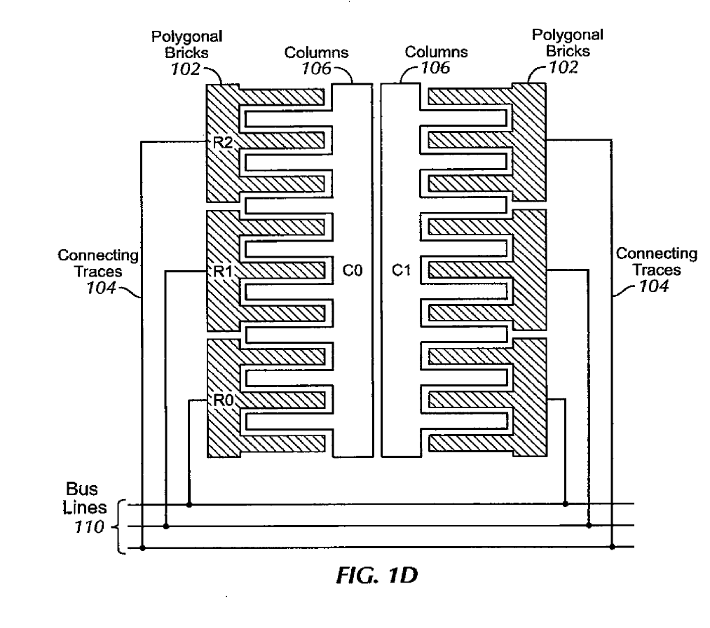

Before introducing the various embodiments of the bandwidth enhancement component of this invention, we first describe, in view of FIGS. 1A-1D, exemplary mutual capacitance multi-touch sensor panels that may be incorporated with such bandwidth enhancement component for improved sensor performance.

FIG. 1A illustrates an exemplary touch sensor panel 100 including sense (or drive) lines (C0-C5) formed as columns 106 and rows of polygonal areas (bricks) 102, where each row of bricks forms a separate drive (or sense) line (R0-R7). In the example of FIG. 1A, connecting traces 104 are routed along only one side of the bricks (a so-called “single escape” configuration). Although a touch sensor panel 100 having six columns and eight rows is shown, it should be understood that any number of columns and rows can be employed. Columns 106 and bricks 102 of FIG. 1A can be formed in a co-planar single layer of conductive material.

To couple bricks 102 in a particular row together, connecting traces 104, which are also formed from a conductive material, can be routed from the bricks along one side of the bricks in the single escape configuration to a particular bus line 110. Connections for each bus line 110 and for columns 106 can be brought off touch sensor panel 100 through flex circuit 112. In touch screen embodiments, the sense lines 106, drive lines 102, and connecting traces 104 can be formed from a substantially transparent material such as Indium Tin Oxide (ITO), although other materials can also be used. The ITO layer can be formed on a single layer on either on the back of a coverglass or on a separate substrate.

FIG. 1B illustrates a close-up view of a portion of the exemplary touch sensor panel 100 of FIG. 1A, showing how bricks 102 can be routed to bus lines 110 using connecting traces 104 in a single escape configuration. In FIG. 1B, the longer connecting traces 104 (e.g. trace R7) can be wider than the shorter connecting traces (e.g. trace R2) to equalize the overall resistance of the traces and to minimize the overall capacitive loads seen by the drive circuitry.

FIG. 1C illustrates a portion of exemplary touch sensor panel 100 of FIG. 1A including bricks 102 associated with columns C0 and C1 and connecting traces 104 (illustrated symbolically as thin lines) coupling the bricks to bus lines 110. In the example of FIG. 1C, which is drawn in a symbolic manner and not to scale for purposes of illustration only, bus line B0 is coupled to brick R0C0 (the closest brick to B0 adjacent to column C0) and R0C1 (the closest brick to B0 adjacent to column C1). Bus line B1 is coupled to brick R1C0 (the next closest brick to B0 adjacent to column C0) and R1C1 (the next closest brick to B0 adjacent to column C1). The pattern repeats for the other bus lines such that bus line B7 is coupled to brick R7C0 (the farthest brick from B0 adjacent to column C0) and R7C1 (the farthest brick from B0 adjacent to column C1).

FIG. 1D illustrates a variation of the exemplary touch sensor panel 100 of FIGS. 1A-1C. In this embodiment, the columns and rows have unique matching polygonal shapes that form an interlocking pattern. As illustrated, the rectangular bricks in FIGS. 1A-1C are replaced by roughly E-shaped polygonal bricks 102, and the columns 106 have adopted a matching shape with one side filling in the gaps in the roughly E-shaped bricks 102. An additional difference between the layout of bricks and columns in this embodiment and the layout of FIGS. 1A-1C is that, instead of having alternating columns and bricks, pairs of columns are lined back to back with each other, as illustrated. However, other shapes and layouts of the bricks and columns may also be used. Although only three rows and two columns are shown in FIG. 1D, the same pattern may expand to include any number of rows and columns. Each row of the E-shaped bricks 102 can be routed to a single bus line 110 using connecting traces 104 in a single escape configuration, as described in the previous embodiment.

In mutual capacitance touch sensor panels, such as the ones shown in FIG. 1A-1D, the drive lines and the sense lines of the touch sensor panel do not make direct electrical contact. The drive lines and the sense lines essentially form two electrodes, a drive electrode and a sense electrode. Each polygonal drive brick adjacent to or near a sense column can represent a capacitive sensing node and can be viewed as a picture element (pixel). A multi-touch panel can be viewed as capturing an “image” of touch with the collection of pixels. The capacitance between row (drive) and column (sense) electrodes appears as a stray capacitance on all columns when the given row is held at direct current (DC) and as a mutual capacitance Csig when the given row is stimulated with an alternating current (AC) signal. The presence of a finger or other object near or on the multi-touch panel can be detected by measuring changes to the capacitance Csig.

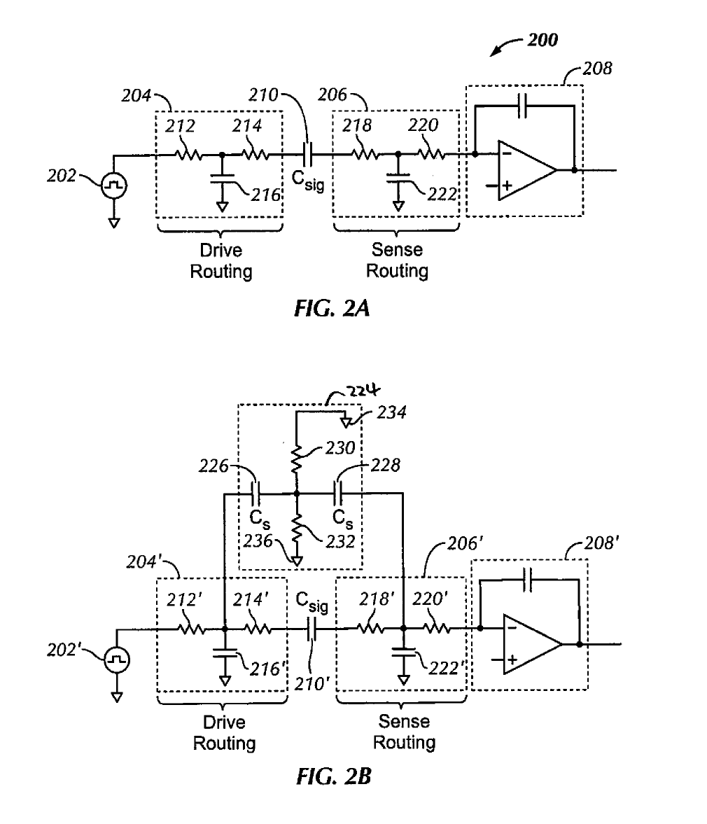

FIG. 2A illustrates an exemplary SITO sensing circuit 200 of one of the capacitive sensing nodes. The sensing circuit 200 of FIG. 2A is not integrated with an embodiment of the bandwidth enhancement component. As illustrated, the sensing circuit 200 includes a source of stimulating voltage 202, a drive line 204 (e.g., a row line), a sense line 206 (e.g., a column line), and a charge amplifier 208. The source of stimulating voltage 202 can generate a burst of square waves or other non-DC signaling in an otherwise DC signal. In some embodiments, the square waves can be preceded and followed by other non-DC signaling. A signal generated by the voltage source 202 can be routed through both metal lines in the border areas and connecting traces in the main area of the touch sensor panel, which may be represented by the various resistor symbols in FIG. 2A.

In operation, a stimulating signal generated by the source 202 first passes through a drive line 204 electrically coupled to the voltage source 202. As illustrated in FIG. 2A, the drive line 204 in this embodiment may be represented as a resistor-capacitor (RC) circuit that includes two serially coupled resistors 212, 214 and a capacitive shunt to ground 216 between the resistors 212, 214. The RC time constant of the drive line 204 may partly determine the bandwidth of the system. The sense line 206 may also be represented as an RC circuit that includes two serially coupled resistors 218, 220 and a capacitive shunt to ground 222 between the resistors. The sense line 206 is coupled to the drive line 204 via a mutual capacitance Csig 210. The touch sensor panel senses a touch when a change in the signal capacitance Csig 210 is detected in response to the presence of a finger or other object over the panel. The sense line 206 may also be coupled to a charge amplifier 208, which enhances the output signal from the sense line 206. In various embodiments, the drive and sense lines may be formed from ITO or other conductive material.

Ideally, most of the stimulating signal is coupled through the capacitor Csig 210 and then enters the sense line 206 to produce the desired level of sensitivity to a touch event on the surface of the panel. However, when the drive lines 204 and connecting traces are made as narrow as possible to increase the space allotted for the sense lines and to separate the drive lines 204 from each other to minimize crosstalk between them, the resistance of the drive lines and connecting traces increases. As the frequency of the stimulating signal goes up, an increasing amount of the signal is lost into the capacitive shunt to ground 216 due to the decreased reactance of the capacitor. As a result, the signal may be much weaker when coupled across the capacitor Csig 210, which in turn can cause problems in processing touch data and interpreting the results. A similar problem also exists with large touch sensor panels that have long drive lines. Because longer lines have higher resistance, the performance of large panels may be significantly affected by the weakened signals coupled onto the sense lines. Embodiments of the bandwidth enhancement component may also be used to preserve bandwidth of the touch sensor circuitry in these large touch sensor panels.

In general, embodiments of this invention seek to negate the effect of the shunting capacitors in the lines by adding circuitry that acts to boost the sensor signal as the stimulating frequency increases. Preferably, the additional circuitry can boost the signal by approximately the same amount that may have been lost due to the shunting capacitances.

FIG. 2B illustrates a modified electrical model of the exemplary SITO sensor illustrated in FIG. 2A according to embodiments of the invention. As shown, the basic sensor circuit of FIG. 2A is now coupled in parallel with a bandwidth enhancement circuit 224. The electrical model of the sensor circuit includes the same components as the one in FIG. 2A, including a source of stimulating voltage 202′, a drive line 204′ (e.g., a row line), a sense line 206′ (e.g., a column line), and a charge amplifier 208′. The drive line 204′ and the sense line 206′ have the same sub-components as their counterparts in FIG. 2A and are similarly coupled with each other by a mutual capacitance Csig 210′.

As illustrated, the bandwidth enhancement circuit 224 serves as another pathway to allow the stimulating signal to travel between the drive line 204′ and the sense line 206′. As illustrated in FIG. 2B, the bandwidth enhancement circuit 224 can be represented as yet another RC circuit coupled in parallel to the sensor circuit. As such, the bandwidth enhancement circuit 224 is also frequency dependent, but produces an increase in the total bandwidth of the overall circuit.

In this embodiment, the bandwidth enhancement circuit 224 can be represented by two serially coupled resistors 230, 232, each of which is also coupled to ground 232, 234 on one end, and two capacitors 226, 228. In particular, one of the capacitors 226 couples the bandwidth enhancement circuit 224 to the drive line 204′, and the other capacitor 228 couples the bandwidth enhancement circuit 224 to the sense line 206′.

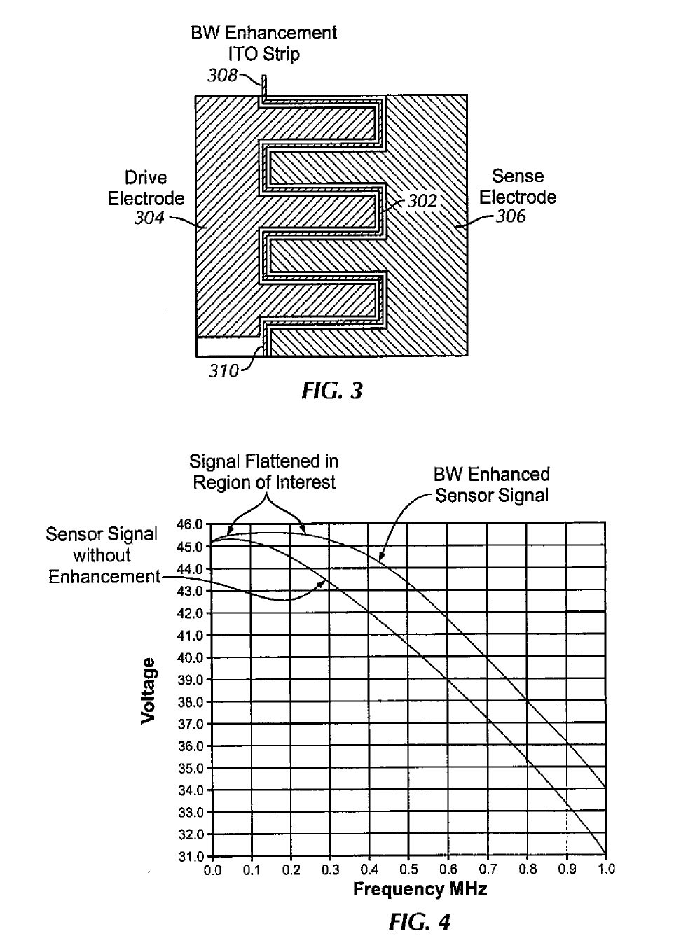

In a touch sensor panel, the bandwidth enhancement circuit, such as the one in FIG. 2B, can be embodied by a conductive strip 302 (e.g., formed from ITO) inserted between a drive electrode 304 and a sense electrode 306, as illustrated in FIG. 3. The drive electrode 304 and the sense electrode 306 shown in FIG. 3 are in the interlocking pattern previously illustrated in FIG. 1D. Nevertheless, panels using different shapes and/or patterns of drive electrodes and sense electrode (e.g., the rectangular bricks and single strip columnar design of FIGS. 1A-1C) may also incorporate a bandwidth enhancement strip between each drive electrode and sense electrode pair to improve its sensitivity.

Referring to FIG. 3, the drive electrode 304 may include the drive line of FIG. 2A and the sense electrode 306 may include the sense line of FIG. 2A. The drive electrode 304 may be capacitively coupled to the bandwidth enhancement strip 302 as represented by capacitor 226 in FIG. 2B. Similarly, the sense electrode 306 may also be capacitively coupled to the bandwidth enhancement strip 302 as represented by capacitor 228 in FIG. 2B. There may be capacitive coupling between the drive electrode 304 and the bandwidth enhancement strip 302 and between the bandwidth enhancement strip 302 and the sense electrode 306 along the full length of the bandwidth enhancement strip 302. As shown in FIG. 2B, the circuit of the bandwidth enhancement strip 302 may include multiple serially coupled resistors representing the resistance of the strip. Each end of the bandwidth enhancement strip 308, 310 may be coupled to ground. The width of the bandwidth enhancement strip 302 and its separation from the electrodes 304, 306 can be varied depending on the amount of enhancement needed for a particular row of sensor elements. If less resistance is desired, a wider strip 302 can be used. Similarly, the capacitance between the electrodes may be adjusted by varying the gap between the electrodes. For example, the gap may be widened if a smaller capacitance is desired.

FIG. 4 is a graph illustrating the effect of the bandwidth enhancement strip on the strength of the signal in a typical mutual capacitance touch sensor panel according to embodiments of the invention. As the graph shows, without the bandwidth enhancement strip, signal strength falls off dramatically as frequency increases from 100 KHz to 300 KHz, the preferred frequency range of the stimulating signal in one embodiment. In contrast, when a bandwidth enhancement strip is added to the sensor circuit, the signal strength stays relatively flat in the same frequency range. Therefore, embodiments of the bandwidth enhancement strip may be used to maintain the desired sensor performance in touch sensor panels within a frequency range. They may also be incorporated into large SITO touch sensor panels that otherwise would not work because of their inherent low bandwidth.

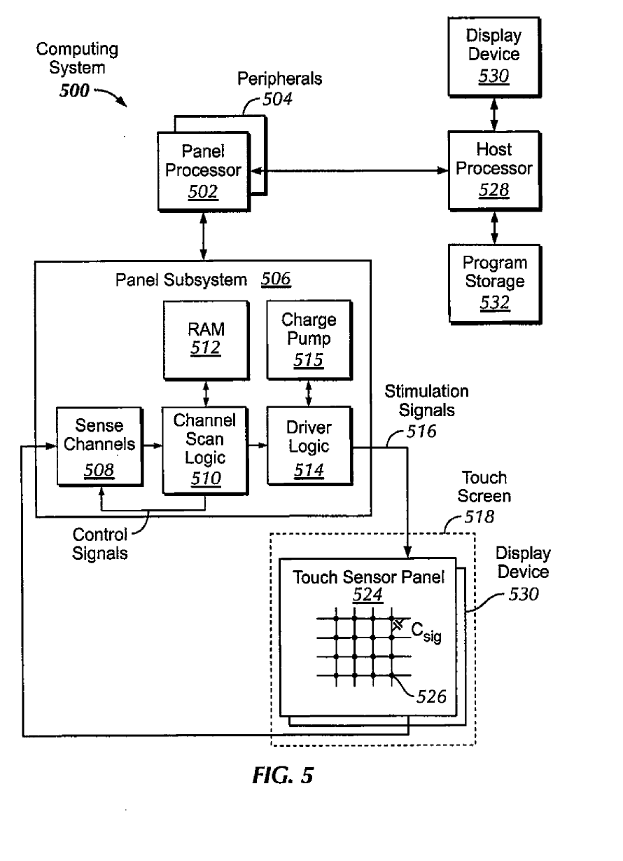

FIG. 5 illustrates exemplary computing system 500 that can include one or more of the embodiments of the invention described above. Computing system 500 can include one or more panel processors 502 and peripherals 504, and panel subsystem 506. Peripherals 504 can include, but are not limited to, random access memory (RAM) or other types of memory or storage, watchdog timers and the like. Panel subsystem 506 can include, but is not limited to, one or more sense channels 508, channel scan logic 510 and driver logic 514. Channel scan logic 510 can access RAM 512, autonomously read data from the sense channels and provide control for the sense channels. In addition, channel scan logic 510 can control driver logic 514 to generate stimulation signals 516 at various frequencies and phases that can be selectively applied to drive lines of touch sensor panel 524. In some embodiments, panel subsystem 506, panel processor 502 and peripherals 504 can be integrated into a single application specific integrated circuit (ASIC).

Touch sensor panel 524 can include a capacitive sensing medium having a plurality of drive lines and a plurality of sense lines, although other sensing media can also be used. In mutual capacitance embodiments, each intersection of drive and sense lines can represent a capacitive sensing node and can be viewed as picture element (pixel) 526, which can be particularly useful when touch sensor panel 524 is viewed as capturing an “image” of touch. (In other words, after panel subsystem 506 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 524 can be coupled to a sense channel 508 (also referred to herein as an event detection and demodulation circuit) in panel subsystem 506. An embodiment of the bandwidth enhancement component may be incorporated into the touch sensor panel 524 as described above to improve the bandwidth/sensitivity of the panel while minimizing border space needed outside the display area and maximizing the sensing element area inside the display area.

Computing system 500 can also include host processor 528 for receiving outputs from panel processor 502 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 528 can also perform additional functions that may not be related to panel processing, and can be coupled to program storage 532 and display device 530 such as an liquid crystal display (LCD) for providing a user interface (UI) to a user of the device. Display device 530 together with touch sensor panel 524, when located partially or entirely under the touch sensor panel, can form touch screen 518.

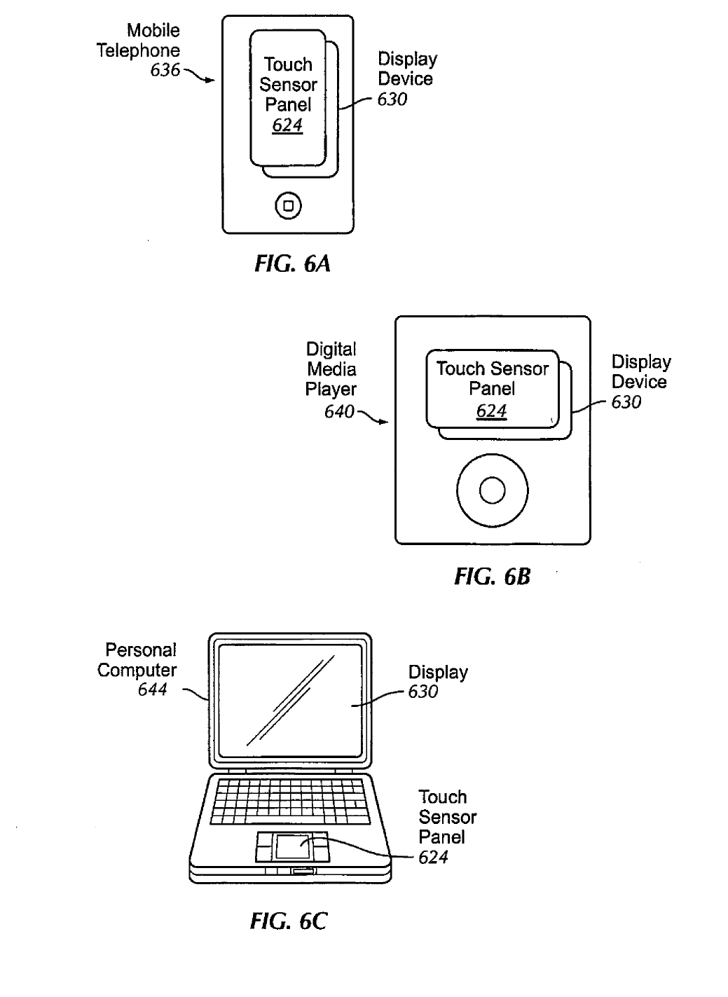

FIG. 6A illustrates exemplary mobile telephone 636 that can include touch sensor panel 624 and display device 630. The touch sensor panel can include the bandwidth enhancement component as described above according to embodiments of the invention.

FIG. 6B illustrates exemplary digital media player 640 that can include touch sensor panel 624 and display device 630. The touch sensor panel can include the bandwidth enhancement component as described above according to embodiments of the invention.

FIG. 6c illustrates an exemplary personal computer 644 that can include touch sensor panel 624 and display device 630. The touch sensor panel can include the bandwidth enhancement component as described above according to embodiments of the invention.

The mobile telephone, media player, and personal computer of FIGS. 6A, 6B and 6C can advantageously benefit from the bandwidth enhancement component of the touch sensor panel to provide better and more accurate detection of touch events, thereby improving the usability of the touch sensor panels of these devices and making the devices more desirable to the users.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A capacitive touch sensor panel, comprising:
a plurality of sense lines formed on one side of a substrate;
a plurality of drive lines formed on a same side of the substrate as the plurality of sense lines, the plurality of drive lines configured for receiving one or more stimulation signals, the plurality of sense lines and the plurality of drive lines forming an array of capacitive sensors; and
a bandwidth enhancement strip formed between one or more of the drive lines and one or more of the sense lines for increasing a capacitance of one or more of the capacitive sensors in response to a frequency increase of the one or more stimulation signals.

2. The capacitive touch sensor panel of claim 1, wherein the bandwidth enhancement strip is capacitively coupled to the one or more drive and sense lines.

3. The capacitive touch sensor panel of claim 1, wherein the bandwidth enhancement strip comprises a continuous strip of conductive material having a certain resistance and a first end and a second end coupled to ground.

4. The capacitive touch sensor panel of claim 1, wherein the bandwidth enhancement strip is formed from ITO.

5. The capacitive touch sensor panel of claim 1, the bandwidth enhancement strip having a width and a separation between the drive and sense lines to create an effective resistance and capacitance, respectively, such that the increase in capacitance of the one or more capacitive sensors substantially offsets an amount of a signal lost due to shunting capacitances in the drive and sense lines.

6. The capacitive touch sensor panel of claim 1, the touch sensor panel integrated within a computer system.

7. The capacitive touch sensor panel of claim 6, the computer system integrated within a mobile telephone.

8. The capacitive touch sensor panel of claim 6, the computer system integrated within a media player.

9. A capacitive sensor, comprising:
a sense electrode formed on one side of a substrate;
a drive electrode formed on a same side of the substrate as the sense electrode and capacitively coupled to the drive electrode, the drive electrode configured for receiving one or more stimulation signals; and
a bandwidth enhancement strip formed between the drive and sense electrode for providing a parallel path for capacitive coupling between the drive and sense electrode.

10. The capacitive sensor of claim 9, wherein the bandwidth enhancement strip is capacitively coupled to the one or more drive and sense lines.

11. The capacitive sensor of claim 9, wherein the bandwidth enhancement strip comprises a continuous strip of conductive material having a certain resistance and a first end and a second end coupled to ground.

12. The capacitive sensor of claim 9, wherein the bandwidth enhancement strip is formed from ITO.

13. The capacitive sensor of claim 9, the bandwidth enhancement strip having a width and a separation between the drive and sense electrode to create an equivalent circuit that substantially offsets an amount of a signal lost due to shunting capacitances in the drive and sense electrodes.

14. The capacitive sensor of claim 9, the capacitive sensor integrated within a touch sensor panel.

15. The capacitive sensor of claim 14, the touch sensor panel integrated within a computer system.

16. The capacitive sensor of claim 15, the computer system integrated within a mobile telephone.

17. The capacitive sensor of claim 15, the computer system integrated within a media player.

18. A bandwidth enhancement strip for a capacitive sensor array having a plurality of drive and sense lines, comprising:
a strip of conductive material formed between one or more of the drive and sense lines for providing a parallel path for capacitive coupling between the one or more drive and sense lines.

19. The bandwidth enhancement strip of claim 18, wherein the strip of conductive material is capacitively coupled to the one or more drive and sense lines.

20. The bandwidth enhancement strip of claim 18, wherein the strip of conductive material includes a first end and a second end coupled to ground.

21. The bandwidth enhancement strip of claim 18, wherein the strip of conductive material is formed from ITO.

22. The bandwidth enhancement strip of claim 18, the strip of conductive material having a width and a separation between the drive and sense lines to create an equivalent circuit that substantially offsets an amount of a signal lost due to shunting capacitances in the drive and sense lines.

23. A method for enhancing the bandwidth of a capacitive touch sensor panel, comprising:
forming a plurality of sense lines on one side of a substrate;
forming a plurality of drive lines on a same side of the substrate as the plurality of sense lines;
configuring the plurality of drive lines for receiving one or more stimulation signals;
forming an array of capacitive sensors from the plurality of sense lines and the plurality of drive lines; and
forming a bandwidth enhancement strip between one or more of the drive lines and one or more of the sense lines for increasing a capacitance between one or more of the capacitive sensors in response to a frequency increase of the one or more stimulation signals.

24. The method of claim 23 further comprising capacitively coupling the bandwidth enhancement strip to the one or more drive and sense lines.

25. The method of claim 23 wherein the bandwidth enhancement strip comprises a continuous strip of conductive material having a certain resistance, and a first end and a second end coupled to ground.

26. The method of claim 23 further comprising creating an effective resistance and capacitance by having a width and a separation between the drive and sense lines, such that the increase in capacitance of the one or more capacitive sensors substantially offsets an amount of a signal lost due to shunting capacitances in the drive and sense lines.

27. A handheld electronic device including a capacitive touch sensor penal, the capacitive touch sensor panel comprising:
a plurality of sense lines formed on one side of a substrate;
a plurality of drive lines formed on a same side of the substrate as the plurality of sense lines, the plurality of drive lines configured for receiving one or more stimulation signals, the plurality of sense lines and the plurality of drive lines forming an array of capacitive sensors; and
a bandwidth enhancement strip formed between one or more of the drive lines and one or more of the sense lines for increasing a capacitance between one or more of the capacitive sensors in response to a frequency increase of the one or more stimulation signals.
